(19) United States
(12) Patent Application Publication
(10) Pub. No.: US 2006/0150656 A1
(43) Pub. Date: Jul. 13, 2006

(54) Beverage cover capable of retaining temperature of beverage enclosed by the cover

(76) Inventor: Nan Chih Lu, Tau Yuan Hsien (TW)

Correspondence Address: LU, Nan Chih, 235 Chung - Ho, Box 8-24, Taipei, TW

(21) Appl. No.: 11/031,908

(22) Filed: Jan. 10, 2005

(51) Int. Cl. F28D 5/00; F17C 13/00

(52) U.S. Cl. 62/304; 62/457.9

(57) ABSTRACT

A beverage cover capable of retaining temperature of beverage enclosed by the cover comprises an inner layer made of permeated material; a water-absorbing material; and an outer layer made of water-proof material. The water-absorbing material is Polycrystalline Sodium Acetate. The inner layer is hodrophil non-weaving cloth. The body has a rectangular shape and is installed with sticky strip. A body is made as a round cylinder and a center of the body serves to receive a beverage can; and a bottom of the body has a bottom plate.

### FIELD OF THE INVENTION

The present invention relates to a beverage cover capable of retaining temperature of beverage enclosed by the cover, wherein originally the water-absorbing material is powders so that it is light and thin to be carried easily and to be stored in a smaller space. Thereby the cost in transfer is saved. It is used to rapidly increase or decrease the temperature of the beverage enclosed therein.

### BACKGROUND OF THE INVENTION

In the prior art, it is often that the beverage is necessary to be cooled or heated so as to match the feeling of the drinker. For example, the juicy or beer is generally drunk in cool state. Thereby they are placed in refrigerator for a time period. However the cooling operation cannot be achieved in a short time and moreover, as the beverage is carried out for a long time, the beverage will restore to environment temperature. Thereby in cool state, the bottle containing the beverage will drop water drops due to cold water adheres on an outer surface of the bottle.

Thereby the same problem is existed for heating the beverage to a higher temperature. The beverage must be heated in a heating device, but as the beverage is carried out from the heating device for a longer time, the beverage will return to environment temperature.

Thereby there is a demand for a novel design which can improve the defect in the prior art.

### SUMMARY OF THE INVENTION

Accordingly, the primary object of the present invention is to provide a beverage cover capable of retaining temperature of beverage enclosed by the cover, wherein originally the water-absorbing material is powders so that it is light and thin to be carried easily and to be stored in a smaller space. Thereby the cost in transfer is saved.

The second object of the present invention is to provide a beverage cover capable of retaining temperature of beverage enclosed by the cover, wherein it is used to rapidly increase or decrease the temperature of the beverage enclosed therein.

To achieve above object, the present invention provide a beverage cover capable of retaining temperature of beverage enclosed by the cover. The cover comprises an inner layer made of permeated material; a water-absorbing material; and an outer layer made of water-proof material. The water-absorbing material is Polycrystalline Sodium Acetate. The inner layer is hodrophil non-weaving cloth. The body has a rectangular shape and is installed with sticky strip. A body is made as a round cylinder and a center of the body serves to receive a beverage can; and a bottom of the body has a bottom plate.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a cross sectional view of the present invention.

FIG. 3 is a schematic view about a second embodiment of the present invention.

FIG. 4 is a schematic view about the third embodiment of the present invention.

FIG. 5 shows an application of the third embodiment of the present invention.

FIG. 6 is a schematic view showing the use of the third embodiment of the present invention.

FIG. 7 is a schematic view of FIG. 6, where the wine bottle is taken out from an ice barrel.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

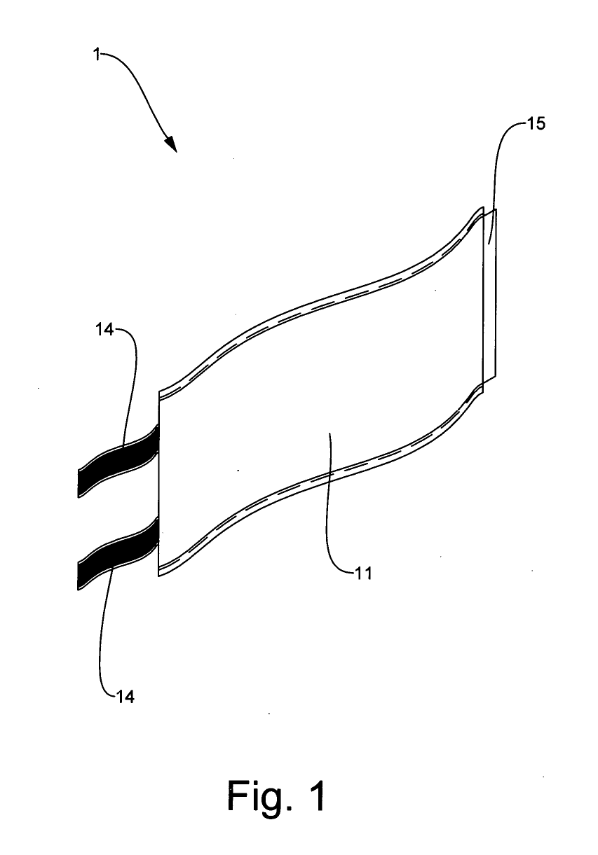

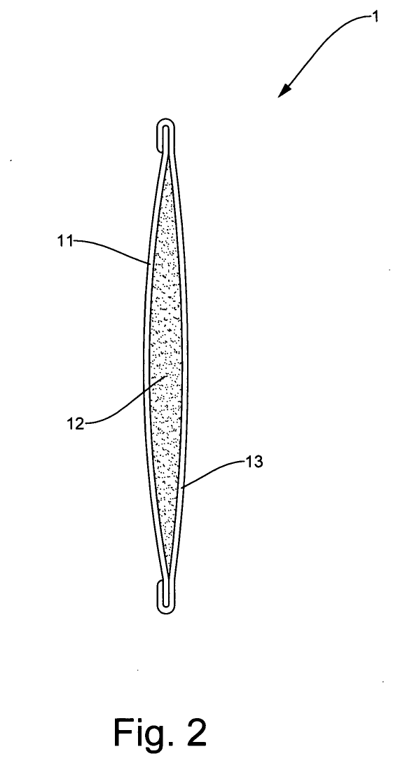

Referring to FIGS. 1 and 2, the beverage cover capable of retaining temperature of the present invention is illustrated. The present invention has a body 1 which has the following elements.

An inner layer 11 is made of permeated material, such as hydrophile non-weaving cloth, but not confined to this.

A water-absorbing material 12 is for example polycrystalline sodium acetate, but not confined to this. Before absorbing water, the water-absorbing material 12 is powders which is light. After absorbing water, it will expand.

An outer layer 13 is made of water-proof material for avoiding the water in the water-absorbing material 12 to drain out.

The body 1 may have a rectangular shape or as a bag. Sticky strips 14, 15 can be installed at predetermined positions thereof.

In application, the body 1 is sunk in ice water through several minutes. The ice water permeates through the inner layer 11 and then enters into the water-absorbing material 12. After the water-absorbing material 12 absorbs the ice water sufficiently, the body 1 is wound around the periphery of a beverage can (not shown) and the sticky strips 14, 15 winds around the beverage can 29 and then they are adhered to one another. By the lower temperature of the water-absorbing material 12, the beverage will cool quickly and retains at a lower temperature for a longer time. Similarly, the body 1 can be sunk in hot water through several minutes. Hot water will permeate into the inner layer 11 and then into the water-absorbing material 12. After the water-absorbing material 12 absorbs hot water sufficiently, the body 1 is wound around the periphery of a beverage can (not shown) and the sticky strips 14, 15 wind around the beverage can 29 and then they are adhered to one another. By the high temperature of the water-absorbing material 12, the beverage will be heated quickly and retains at a higher temperature for a longer time.

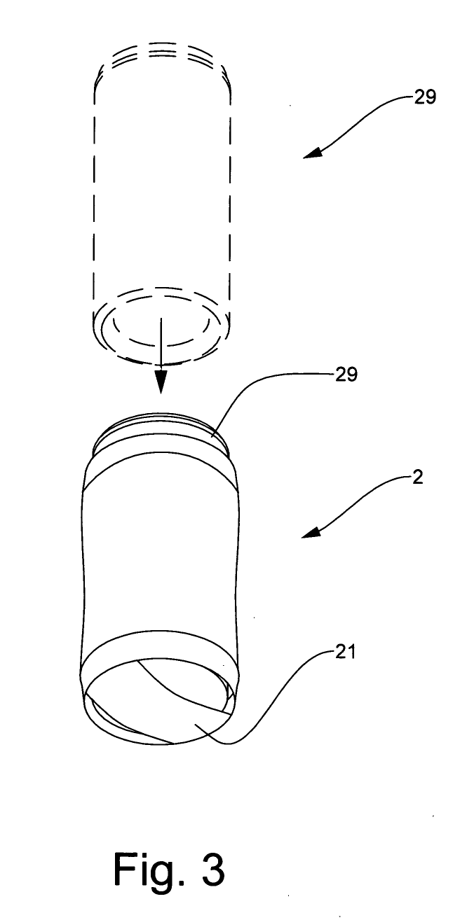

With reference to FIG. 3, another embodiment of the present invention is illustrated. The body 2 is made as a hollow round cylinder. A bottom thereof is added with a bottom plate 21. Thereby the beverage can 29 placed into the body 2 will retain therein not to fall out from the body 2.

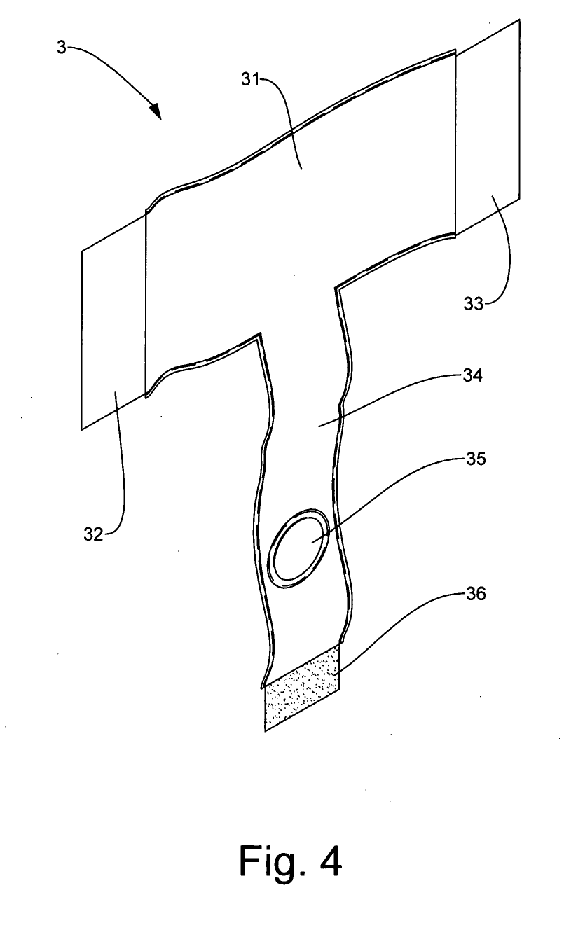

Referring to FIG. 4, a further embodiment of the present invention is illustrated. The body 3 has an approximate T shape. The body 3 has a first unit 31 and a second unit 34. The second unit 34 extended from a bottom of the first unit 31. The first unit 31 is vertical to the second unit 34. An opening 35 is formed on the second unit 34. A distal end of the second unit 34 has a sticky strip 36. The body 3 is made of elastic material.

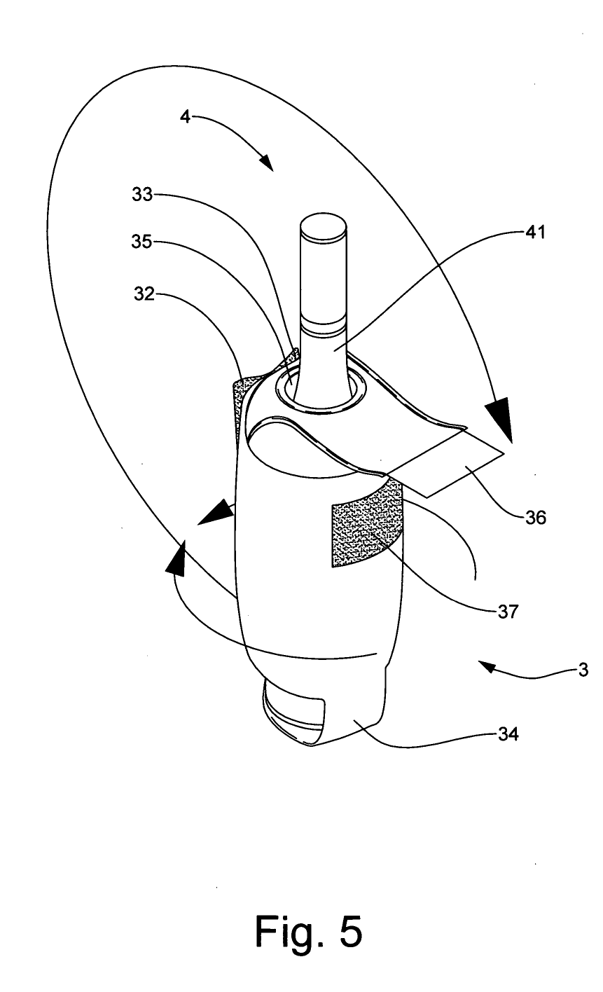

With reference to FIG. 5, when the body 3 serves to wind around a long wine bottle 4. The bottle 4 is placed in the inner edge of the body 3. The first unit 31 serves to enclose the bottle body. The second unit 34 serves to wind the bottle 4 from a bottom of the bottle. Then the opening 35 is aligned to the bottle opening 41. Finally, the sticky strips 32, 33, 36 and 37 are adhered to one another so that the body 3 is steadily added to the long wine bottle 4.

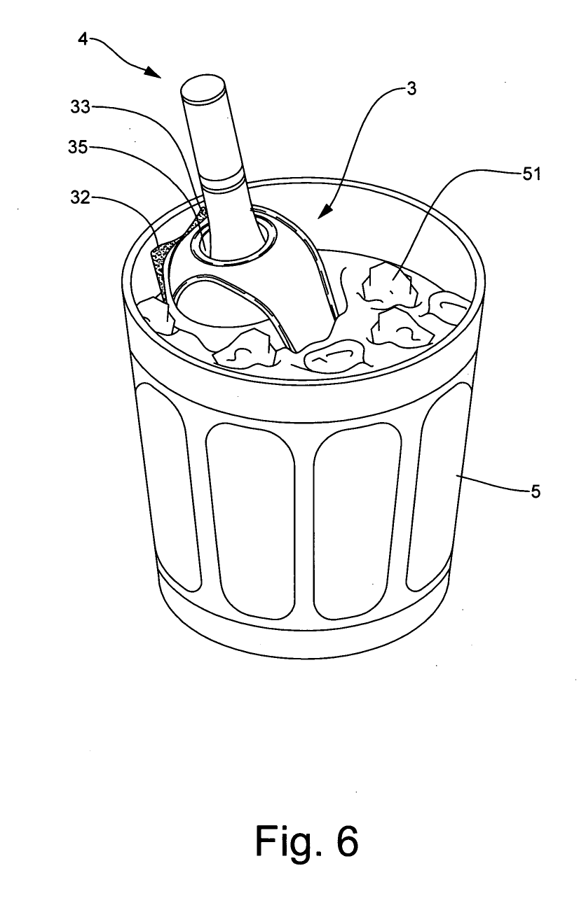

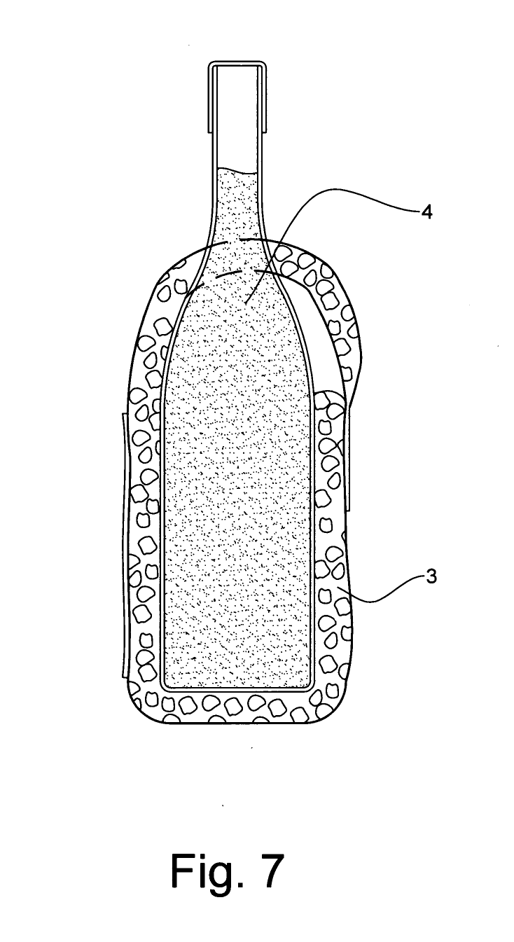

Referring to FIG. 6, it is illustrated that the body 3 is placed on the long wine bottle 4 and then is placed in to an ice barrel 5 with ice bricks 51 therein. In the present invention, the body 3 can be placed in the barrel 5 independently. Thus, the wine bottle 4 will cool rapidly. When the body 3 and the wind bottle 4 are taken out from the barrel 4 (referring to FIG. 7), the body 3 still has the effect of cooling the bottle 4. Thereby it is only necessary to dry the body 3 and bottle 4 slightly so that water can drop out. Similarly, the body 3 can be placed in hot water 3, and has the same effect as it wind around the bottle wine 4.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A beverage cover capable of retaining temperature of beverage enclosed by the cover comprising:
a water-absorbing material;
an inner layer made of permeated material enclosing the water-absorbing material; and
an outer layer made of water-proof material enclosing the inner layer.

2. The beverage cover capable of retaining temperature of beverage enclosed by the cover as claimed in claim 1, wherein the water-absorbing material is Polycrystalline Sodium Acetate.

3. The beverage cover capable of retaining temperature of beverage enclosed by the cover as claimed in claim 1, wherein the inner layer is hodrophil non-weaving cloth.

4. The beverage cover capable of retaining temperature of beverage enclosed by the cover as claimed in claim 1, wherein the body has a rectangular shape and is installed with sticky strips.

5. The beverage cover capable of retaining temperature of beverage enclosed by the cover as claimed in claim 1, wherein a body is made as a round cylinder and a center of the body serves to receive a beverage can; and a bottom of the body has a bottom plate.

6. The beverage cover capable of retaining temperature of beverage enclosed by the cover as claimed in claim 1, wherein the body has a first unit and a second unit; the second unit is extended from a bottom of the first unit; the first unit is vertical to the second unit; an opening is formed on the second unit; a distal end of the second unit has a sticky strip; and the body is made of elastic material.
